(19) United States
(12) Patent Application Publication
(10) Pub. No.: US 2021/0192375 A1
(43) Pub. Date: Jun. 24, 2021

(54) KNOWLEDGE-BASED MANAGEMENT OF RECOGNITION MODELS IN ARTIFICIAL INTELLIGENCE SYSTEMS

(71) Applicant: Huawei Technologies Co., Ltd., Shenzhen (CN)

(72) Inventors: Yinglong Xia, San Jose, CA (US); Kien Luu, Bellevue, WA (US)

(21) Appl. No.: 17/249,584

(22) Filed: Mar. 5, 2021

Related U.S. Application Data
(63) Continuation of application No. PCT/CN2019/090111, filed on Jun. 5, 2019.
(60) Provisional application No. 62/734,016, filed on Sep. 20, 2018.

(51) Int. Cl. G06N 5/04; G06N 5/02; G06N 20/00

(52) U.S. Cl. CPC G06N 5/04; G06K 9/00979; G06N 20/00; G06N 5/02

(57) ABSTRACT

An artificial intelligence device for identifying an object in a data set includes processing circuitry configured to receive the data set and a query including object. The processing circuitry selects one or more models using an entity knowledge database that includes a plurality of entities corresponding to objects to be identified. Each of a plurality or recognition models is linked to multiple entities of the entity knowledge database so that the processing circuitry may select multiple recognition models. The processing circuitry then processes the data set using the selected recognition model or models to provide an indication of whether the data set includes the at least one object. The entities may be ontologically coupled in the database so that, even if the object does not have a corresponding entity in the database, the object may be identified using models selected based on the ontology.

### CLAIM OF PRIORITY

This application is a continuation application of International Application No. PCT/CN2019/090111, filed Jun. 5, 2019, which claims the benefit of priority to U.S. Provisional Application No. 62/734,016, filed Sep. 20, 2018, and titled “Knowledge-Based Management of Recognition Models in Artificial Intelligence Systems”, the benefit of priority of each of which is claimed herein, and which applications and publication are hereby incorporated herein by reference in their entirety.

### TECHNICAL FIELD

The present disclosure is related to artificial intelligence (AI) systems and, in particular, to knowledge-based tools for organizing and using recognition models to respond to queries involving objects in a data set.

### BACKGROUND

Entity recognition of objects in a data set, for example items in an image or video file or words in an audio file, is a widely used AI application.

The data sets may include numerous entities each of which may have multiple granularities. Each type of entity is typically recognized by one or more dedicated models. As an increasing number of models appear on AI platforms, however, it becomes difficult for users to determine which model(s) are available and which models should be used to recognize a particular object.

### SUMMARY

According to an aspect, a device for identifying at least one object in a data set includes a memory storing instructions and one or more processors in communication with the memory, wherein the one or more processors execute the instructions to: receive a data set and a query including the at least one object in the data set; select at least one recognition model using an entity knowledge database including a plurality of entities corresponding to objects to be identified, wherein each recognition model of a plurality of recognition models is linked to multiple entities of the entity knowledge database; and process the data set using the at least one selected recognition model to provide an indication of whether the data set includes the at least one object.

Optionally, in the preceding aspect, the one or more processors execute further instructions to: receive the plurality of recognition models, each recognition model including at least one annotation; and for each recognition model: identify at least one entity of the entity knowledge database that corresponds to the recognition model, based on the at least one annotation of the recognition model, and link the recognition model to the at least one entity in the entity knowledge database.

Optionally, in any preceding aspect, the at least one recognition model includes multiple recognition models and each recognition model of the multiple recognition models includes at least one parameter indicating computing resources to be used to process the data set using the recognition model; and the one or more processors execute the instructions to process the data set by processing the data set using at least one recognition model from the multiple recognition models, the at least one recognition model having indicated computing resources that are compatible with resources available to the one or more processors.

Optionally, in any preceding aspect, the one or more processors execute the instructions to obtain additional resources from a network-connected service before selecting the recognition model.

Optionally, in any preceding aspect, the entity knowledge database is a graph database; the entities of the entity knowledge graph database are ontologically coupled nodes of the entity knowledge graph database such that a recognition model which is directly linked to one node in the entity knowledge database is linked to all nodes in the entity knowledge database that are ontologically coupled to the one node; the entity knowledge graph database includes a node corresponding to the at least one object and the node corresponding to the at least one object is not directly linked to a recognition model; and the one or more processors execute the instructions to select, as the at least one recognition model, one or more recognition models directly linked to at least one node in the entity knowledge database that is ontologically coupled to the node corresponding to the at least one object.

Optionally, in any preceding aspect, the one or more processors execute the instructions to: select, as the one or more recognition models associated with the ontologically coupled nodes, a plurality of recognition models linked to a respective plurality of nodes ontologically coupled to the node corresponding to the at least one object; process the data set using the selected plurality of recognition models; and combine results of processing the selected plurality of recognition models to provide the indication of whether the data set includes the at least one object.

Optionally, in any preceding aspect, the entity knowledge database is a graph database; the entity-knowledge graph database includes a plurality of ontologically organized nodes corresponding to the at least one object at different levels of generality and the one or more processors execute the instructions to: select, as the at least one recognition model, a plurality of recognition models associated with the plurality of nodes corresponding to the different levels of generality of the at least one object; process the data set using the selected plurality of recognition models; and combine results of the processing of the selected plurality of recognition models to provide the indication of whether the data set includes the at least one object.

According to an aspect, a device for identifying at least one object in a data set includes a memory storing instructions and one or more processors in communication with the memory, wherein the one or more processors execute the instructions to: receive a plurality of recognition models, each recognition model including a plurality of annotations; establish links among each received recognition model of the plurality of recognition models and multiple respective entities of an entity knowledge database according to the annotations of the recognition model; receive a data set and a query to identify at least one object in the data set; select at least one recognition model from the entity knowledge database to identify the at least one object, the at least one recognition model being linked to at least one entity in the entity knowledge database corresponding to the at least one object; and process the data set using the at least one selected recognition model to provide an indication of whether the data set includes the at least one object.

Optionally, in the preceding aspect, the entity knowledge database is a graph database; the entities of the entity knowledge graph database are ontologically coupled such that directly linking a recognition model to one node in the entity knowledge graph database links the recognition model to all nodes in the entity knowledge graph database that are ontologically coupled to the one node; the entity knowledge database includes a node corresponding to the at least one object and the node corresponding to the at least one object is not directly linked to any of the plurality of recognition models; and the one or more processors execute the instructions to select, as the at least one recognition model, at least one recognition model that is ontologically coupled to the node corresponding to the at least one object and that is linked to at least one respective recognition model of the plurality of recognition models.

Optionally, in any preceding aspect, the one or more processors execute the instructions to: identify, as the at least one identified recognition model, a plurality of identified recognition models linked to a plurality of nodes that are ontologically coupled to the node corresponding to the at least one object; process the data set using the selected plurality of identified recognition models; and combine results of processing the selected plurality of identified recognition models to provide the indication of whether the data set includes the at least one object.

Optionally, in any preceding aspect, the entity knowledge database includes a plurality of ontologically organized nodes corresponding to the at least one object at different levels of generality and the one or more processors execute the instructions to: select, as the identified plurality of recognition models, respective models associated with the plurality of nodes corresponding to the different levels of generality of the at least one object; process the data set using the selected plurality of recognition models; and combine results of the processing of the selected plurality of identified recognition models to provide the indication of whether the data set includes the at least one object.

Optionally, in any preceding aspect, the data set includes an image frame and the at least one object includes an entity of the entity knowledge database.

searching an entity knowledge database including a plurality of nodes corresponding to objects to be identified, wherein each recognition model of a plurality of recognition models is linked to multiple nodes of the entity knowledge database; selecting at least one recognition model of the plurality of recognition models to be used to identify the at least one object in response to the search of the entity knowledge database; and processing the data set using the at least one selected recognition model to provide an indication of whether the data set includes the at least one object.

Optionally, in any preceding aspect, the method further includes receiving the plurality of recognition models, each recognition model including at least one annotation; and for each recognition model: identifying at least one entity of the entity knowledge database that corresponds to the recognition model, based on the at least one annotation of the recognition model; and linking the recognition model to the at least one entity in the entity knowledge database.

Optionally, in any preceding aspect, the at least one recognition model includes multiple recognition models and each recognition model of the multiple recognition models includes at least one parameter indicating computing resources to be used to process the data set using the recognition model; and the method further comprises processing the data set using at least one recognition model from the multiple recognition models, the at least one recognition model having indicated computing resources that are compatible with resources available to the one or more processors.

Optionally, in any preceding aspect, the method includes, obtaining additional resources from a network-connected service before selecting the recognition model.

Optionally, in any preceding aspect, the entity knowledge database is a graph database having entities that are ontologically coupled to nodes of the entity knowledge graph database such that a recognition model which is directly linked to one node in the entity knowledge database is linked to all nodes in the entity knowledge database that are ontologically coupled to the one node and the entity knowledge graph database includes a node corresponding to the at least one object and the node corresponding to the at least one object is not directly linked to a recognition model; and the method further comprises selecting, as the at least one recognition model, one or more recognition models directly linked to at least one node in the entity knowledge database that is ontologically coupled to the node corresponding to the at least one object.

Optionally, in any preceding aspect, the method includes selecting, as the one or more recognition models associated with the ontologically coupled nodes, a plurality of recognition models linked to a respective plurality of nodes ontologically coupled to the node corresponding to the at least one object; processing the data set using the selected plurality of recognition models; and combining results of processing the selected plurality of recognition models to provide the indication of whether the data set includes the at least one object.

Optionally, in any preceding aspect, the entity knowledge database is a graph database that includes a plurality of ontologically organized nodes corresponding to the at least one object at different levels of generality; and the method further comprises: selecting, as the at least one recognition model, a plurality of recognition models associated with the plurality of nodes corresponding to the different levels of generality of the at least one object; processing the data set using the selected plurality of recognition models; and combining results of the processing of the selected plurality of recognition models to provide the indication of whether the data set includes the at least one object.

According to an aspect, a method for identifying at least one object in a data set includes: receiving a plurality of recognition models, each recognition model including a plurality of annotations; establishing links among each received recognition model of the plurality of recognition models and multiple respective entities of an entity knowledge database according to the annotations of the recognition model; receiving a data set and a query to identify at least one object in the data set; selecting at least one recognition model from the entity knowledge database to identify the at least one object, the at least one recognition model being linked to at least one entity in the entity knowledge database corresponding to the at least one object; and processing the data set using the at least one selected recognition model to provide an indication of whether the data set includes the at least one object.

Optionally, in the preceding aspect, the entity knowledge database is a graph database having entities that are ontologically coupled to nodes of the entity knowledge graph database such that directly linking a recognition model to one node in the entity knowledge graph database links the recognition model to all nodes in the entity knowledge graph database that are ontologically coupled to the one node and the entity knowledge database includes a node corresponding to the at least one object and the node corresponding to the at least one object is not directly linked to any of the plurality of recognition models; and the method further comprises selecting, as the at least one recognition model, at least one recognition model that is ontologically coupled to the node corresponding to the at least one object and that is linked to at least one respective recognition model of the plurality of recognition models.

Optionally, in any preceding aspect, the method further includes identifying, as the at least one identified recognition model, a plurality of identified recognition models linked to a plurality of nodes that are ontologically coupled to the node corresponding to the at least one object; processing the data set using the selected plurality of identified recognition models; and combining results of processing the selected plurality of identified recognition models to provide the indication of whether the data set includes the at least one object.

Optionally, in any preceding aspect, the entity knowledge database includes a plurality of ontologically organized nodes corresponding to the at least one object at different levels of generality; and the method further comprises: selecting, as the identified plurality of recognition models, respective models associated with the plurality of nodes corresponding to the different levels of generality of the at least one object; processing the data set using the selected plurality of recognition models; and combining results of the processing of the selected plurality of identified recognition models to provide the indication of whether the data set includes the at least one object.

Optionally, in any preceding aspect, the data set includes an image frame and the at least one object includes an entity of the entity knowledge database.

According to an aspect, a computer-readable medium storing computer instructions for identifying an object in a data set that, when executed by one or more processors, cause the one or more processors to: search an entity knowledge database including a plurality of nodes corresponding to objects to be identified, wherein each recognition model of a plurality of recognition models is linked to multiple nodes of the entity knowledge database; select at least one recognition model of the plurality of recognition models to be used to identify the at least one object in response to the search of the entity knowledge database; and process the data set using the at least one selected recognition model to provide an indication of whether the data set includes the at least one object.

Optionally, in the preceding aspect, the computer instructions, when executed by the one or more processors, cause the one or more processors to: receive the plurality of recognition models, each recognition model including at least one annotation; and for each recognition model: identify at least one entity of the entity knowledge database that corresponds to the recognition model, based on the at least one annotation of the recognition model; and link the recognition model to the at least one entity in the entity knowledge database.

Optionally, in any preceding aspect, the at least one recognition model includes multiple recognition models and each recognition model of the multiple recognition models includes at least one parameter indicating computing resources to be used to process the data set using the recognition model; and the computer instructions, when executed by the one or more processors, cause the one or more processors to process the data set using at least one recognition model from the multiple recognition models, the at least one recognition model having indicated computing resources that are compatible with resources available to the one or more processors.

Optionally, in any preceding aspect, the computer instructions, when executed by the one or more processors, cause the one or more processors to obtain additional resources from a network-connected service before selecting the recognition model.

Optionally, in any preceding aspect, the entity knowledge database is a graph database having entities that are ontologically coupled to nodes of the entity knowledge graph database such that a recognition model which is directly linked to one node in the entity knowledge database is linked to all nodes in the entity knowledge database that are ontologically coupled to the one node and the entity knowledge graph database includes a node corresponding to the at least one object and the node corresponding to the at least one object is not directly linked to a recognition model; and the computer instructions, when executed by the one or more processors, cause the one or more processors to select, as the at least one recognition model, one or more recognition models directly linked to at least one node in the entity knowledge database that is ontologically coupled to the node corresponding to the at least one object.

Optionally, in any preceding aspect, the computer instructions, when executed by the one or more processors, cause the one or more processors to: select, as the one or more recognition models associated with the ontologically coupled nodes, a plurality of recognition models linked to a respective plurality of nodes ontologically coupled to the node corresponding to the at least one object; process the data set using the selected plurality of recognition models; and combine results of processing the selected plurality of recognition models to provide an indication of whether the data set includes the at least one object.

Optionally, in any preceding aspect, the entity knowledge database is a graph database that includes a plurality of ontologically organized nodes corresponding to the at least one object at different levels of generality; and the computer instructions, when executed by the one or more processors, cause the one or more processors to: select, as the at least one recognition model, a plurality of recognition models associated with the plurality of nodes corresponding to the different levels of generality of the at least one object;

process the data set using the selected plurality of recognition models; and combine results of the processing of the selected plurality of recognition models to provide the indication of whether the data set includes the at least one object.

According to an aspect, a computer-readable medium storing computer instructions for identifying an object in a data set that, when executed by one or more processors, cause the one or more processors to: receive a plurality of recognition models, each recognition model including a plurality of annotations; establish links among each received recognition model of the plurality of recognition models and multiple respective entities of an entity knowledge database according to the annotations of the recognition model;

receive a data set and a query to identify at least one object in the data set; selecting at least one recognition model from the entity knowledge database to identify the at least one object, the at least one recognition model being linked to at least one entity in the entity knowledge database corresponding to the at least one object; and process the data set using the at least one selected recognition model to provide an indication of whether the data set includes the at least one object.

Optionally, in the preceding aspect, the entity knowledge database is a graph database having entities that are ontologically coupled to nodes of the entity knowledge graph database such that directly linking a recognition model to one node in the entity knowledge graph database links the recognition model to all nodes in the entity knowledge graph database that are ontologically coupled to the one node and the entity knowledge database includes a node corresponding to the at least one object and the node corresponding to the at least one object is not directly linked to any of the plurality of recognition models; and the computer instructions, when executed by the one or more processors, cause the one or more processors to select, as the at least one recognition model, at least one recognition model that is ontologically coupled to the node corresponding to the at least one object and that is linked to at least one respective recognition model of the plurality of recognition models.

Optionally, in any preceding aspect, the computer instructions, when executed by the one or more processors, further cause the one or more processors to: identify, as the at least one identified recognition model, a plurality of identified recognition models linked to a plurality of nodes that are ontologically coupled to the node corresponding to the at least one object;

process the data set using the selected plurality of identified recognition models; and combine results of processing the selected plurality of identified recognition models to provide the indication of whether the data set includes the at least one object.

Optionally, in any preceding aspect, the entity knowledge database includes a plurality of ontologically organized nodes corresponding to the at least one object at different levels of generality; and the computer instructions, when executed by the one or more processors, further cause the one or more processors to: select as the identified plurality of recognition models, respective models associated with the plurality of nodes corresponding to the different levels of generality of the at least one object; process the data set using the selected plurality of recognition models; and combine results of the processing of the selected plurality of identified recognition models to provide the indication of whether the data set includes the at least one object.

Optionally, in any preceding aspect, the data set includes an image frame and the at least one object includes an entity of the entity knowledge database.

According to an aspect, an apparatus for identifying an object in a data set includes: means for searching an entity knowledge database including a plurality of nodes corresponding to objects to be identified, wherein each recognition model of a plurality of recognition models is linked to multiple nodes of the entity knowledge database; means for selecting at least one recognition model of the plurality of recognition models to be used to identify the at least one object in response to the search of the entity knowledge database; and means for processing the data set using the at least one selected recognition model to provide an indication of whether the data set includes the at least one object.

Optionally, in any preceding aspect, the apparatus includes means for receiving the plurality of recognition models, each recognition model including at least one annotation; and for each recognition model: means for identifying at least one entity of the entity knowledge database that corresponds to the recognition model, based on the at least one annotation of the recognition model; and means for linking the recognition model to the at least one entity in the entity knowledge database.

Optionally, in any preceding aspect, the at least one recognition model includes multiple recognition models and each recognition model of the multiple recognition models includes at least one parameter indicating computing resources to be used to process the data set using the recognition model; and the apparatus further comprises means for processing the data set using at least one recognition model from the multiple recognition models, the at least one recognition model having indicated computing resources that are compatible with resources available to the one or more processors.

Optionally, in any preceding aspect, the apparatus includes a means for obtaining additional resources from a network-connected service before selecting the recognition model.

Optionally, in any preceding aspect, the entity knowledge database is a graph database having entities that are ontologically coupled to nodes of the entity knowledge graph database such that a recognition model which is directly linked to one node in the entity knowledge database is linked to all nodes in the entity knowledge database that are ontologically coupled to the one node and the entity knowledge graph database includes a node corresponding to the at least one object and the node corresponding to the at least one object is not directly linked to a recognition model; and the apparatus further comprises means for selecting, as the at least one recognition model, one or more recognition models directly linked to at least one node in the entity knowledge database that is ontologically coupled to the node corresponding to the at least one object.

Optionally, in any preceding aspect, the apparatus includes a means for selecting, as the one or more recognition models associated with the ontologically coupled nodes, a plurality of recognition models linked to a respective plurality of nodes ontologically coupled to the node corresponding to the at least one object; means for processing the data set using the selected plurality of recognition models; and means for combining results of processing the selected plurality of recognition models to provide the indication of whether the data set includes the at least one object.

Optionally, in any preceding aspect, the entity knowledge database is a graph database that includes a plurality of ontologically organized nodes corresponding to the at least one object at different levels of generality; and the apparatus further comprises: means for selecting, as the at least one recognition model, a plurality of recognition models associated with the plurality of nodes corresponding to the different levels of generality of the at least one object; means for processing the data set using the selected plurality of recognition models; and means for combining results of the processing of the selected plurality of recognition models to provide the indication of whether the data set includes the at least one object.

Optionally, in any preceding aspect, the apparatus includes means for receiving a plurality of recognition models, each recognition model including a plurality of annotations; means for establishing links among each received recognition model of the plurality of recognition models and multiple respective entities of an entity knowledge database according to the annotations of the recognition model; means for receiving a data set and a query to identify at least one object in the data set; means for selecting at least one recognition model from the entity knowledge database to identify the at least one object, the at least one recognition model being linked to at least one entity in the entity knowledge database corresponding to the at least one object; and means for processing the data set using the at least one selected recognition model to provide an indication of whether the data set includes the at least one object.

Optionally, in any preceding aspect, the entity knowledge database is a graph database having entities that are ontologically coupled to nodes of the entity knowledge graph database such that directly linking a recognition model to one node in the entity knowledge graph database links the recognition model to all nodes in the entity knowledge graph database that are ontologically coupled to the one node and the entity knowledge database includes a node corresponding to the at least one object and the node corresponding to the at least one object is not directly linked to any of the plurality of recognition models; and the apparatus further comprises means for selecting, as the at least one recognition model, at least one recognition model that is ontologically coupled to the node corresponding to the at least one object and that is linked to at least one respective recognition model of the plurality of recognition models.

Optionally, in any preceding aspect, the apparatus includes means for identifying, as the at least one identified recognition model, a plurality of identified recognition models linked to a plurality of nodes that are ontologically coupled to the node corresponding to the at least one object; means for processing the data set using the selected plurality of identified recognition models; and means for combining results of processing the selected plurality of identified recognition models to provide the indication of whether the data set includes the at least one object.

Optionally, in any preceding aspect, the entity knowledge database includes a plurality of ontologically organized nodes corresponding to the at least one object at different levels of generality; and the apparatus further comprises: means for selecting as the identified plurality of recognition models, respective models associated with the plurality of nodes corresponding to the different levels of generality of the at least one object; means for processing the data set using the selected plurality of recognition models; and means for combining results of the processing of the selected plurality of identified recognition models to provide the indication of whether the data set includes the at least one object.

### BRIEF DESCRIPTION OF THE DRAWINGS

FIG. 1 is a functional block diagram of an AI recognition system, according to an example embodiment.

FIG. 2 is a system diagram showing an example AI operating environment.

FIG. 3 is a diagram useful for describing visual entity recognition, according to an example embodiment.

FIGS. 4A and 4B are flow-chart diagrams of an example AI recognition process, according to an example embodiment.

FIG. 5A is a graph diagram of an entity-knowledge graph database, according to an example embodiment.

FIG. 5B is a graph diagram illustrating methods for affiliating entities using in a knowledge graph using conceptual subspaces that relate objects in a high-dimensional space, according to an example embodiment.

FIG. 6 is a graph diagram of a process for identifying objects, according to an example embodiment.

FIG. 7 is a block diagram illustrating circuitry for clients, servers, network-connected resources for implementing algorithms and performing methods, according to example embodiments.

### DETAILED DESCRIPTION

In the following description, reference is made to the accompanying drawings that form a part hereof, and in which are shown, by way of illustration, specific embodiments which may be practiced. These embodiments are described in sufficient detail to enable those skilled in the art to practice the disclosed subject matter. It is to be understood that other embodiments may be utilized, and that structural, logical and electrical changes may be made without departing from the scope of the appended claims. The following description of example embodiments is, therefore, not to be taken to limit the appended claims.

The functions or algorithms described herein may be implemented using software, in some embodiments. The software may consist of computer executable instructions stored on computer readable media or computer readable storage devices such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a processing circuitry that may include one or more of a digital signal processor, application specific integrated circuit (ASIC), field programmable gate array (FPGA), single core or multi-core microprocessor, or other type of processor operating on a computer system, such as a personal computer, server or other computer system, turning such computer system into a specifically programmed machine.

The embodiments described below address the increasing number of recognition models that are available to AI platforms. These embodiments employ an entity-knowledge database, such as an entity-knowledge graph database, to organize the models so that users may arbitrarily describe the objects to be recognized in a data set and the system may automatically select one model or a set of models to perform entity recognition on the data set based on that description. Example entity-knowledge databases may include or be generated from commercially available knowledge databases such as DBPEDIA, Microsoft® Satori®, and/or Google® Graph®. For example, a commercial AI system may employ its own dedicated knowledge database similar to one of the commercial databases described above. In this instance, the entity-knowledge graph database may be the dedicated knowledge database. In another example, the entity-knowledge database may be generated from one or more of the commercial databases to provide a database focused on a particular recognition task or set of recognition tasks.

Some embodiments described below organize models for recognition of objects in a data set using an AI platform in such a way that all recognition models are stored in a model plane of a data store. The models in the model plane are linked to an entity-knowledge database such that an ontology inherent in the knowledge database may be used to identify appropriate recognition models to be used for a received query from a flexible and/or approximate description of the object to be recognized in the query.

Some embodiments described below automatically select a single recognition model or orchestrate use of a set of recognition models to improve the recognition of objects in an arbitrary data set. These embodiments may use a knowledge database and/or automatically determined conceptual relationships among objects to select the model or models to be used in the recognition process.

The embodiments below are described in the context of an AI image recognition system in which a user provides or indicates a data set including an image, set of images or video to be searched and also provides a query asking if a particular object or class of objects is represented in the data set. The query may be a specific query, such as, “does the data set include a German Shepard” or it may be a more general query, such as, “identify all of the animals in the data set.”

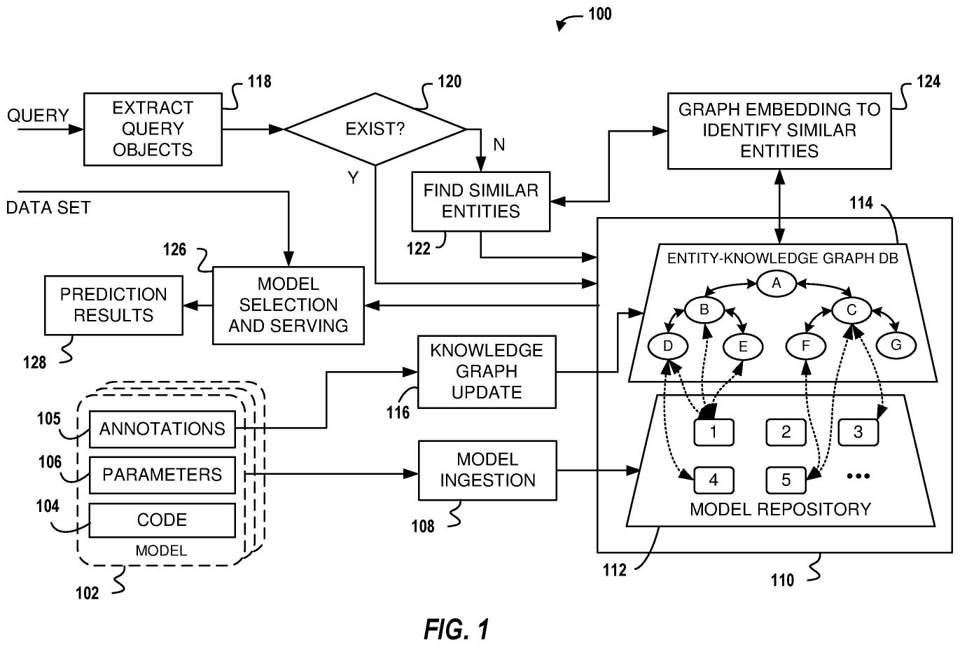

FIG. 1 is a functional block diagram of an AI recognition system 100, according to an example embodiment. The example system shown 100 includes a set of recognition models 102, each including model code 104, model annotations 105, and model parameters 106. The model code 104 is executed by a processing system (e.g. the model selection and serving process 126) to identify or classify specific objects that the recognition model 102 is configured to recognize in a data set provided to the system 100. The model annotations 105 describe the objects or classes of objects that may be recognized using the model code 104 and may also include other data, such as features of a feature vector used by the recognition model 102.

The system 100 also includes a recognition model ingestion process 108 and a data store 110, including a model repository 112 and an entity-knowledge graph database 114. The example model repository 112 includes five recognition models, labeled 1-5. The example entity knowledge graph database 114 includes one first level entity, labeled A, two second level entities, labeled B and C and four third-level entities labeled D, E, F, and G. The nodes of the database are arranged ontologically such that the granularity of the entities represented by the nodes A-G increases from top to bottom. Thus, nodes B and

C represent respectively different subsets of node A, nodes D and E represent respective subsets of node B and nodes F and G represent respective subsets of node C.

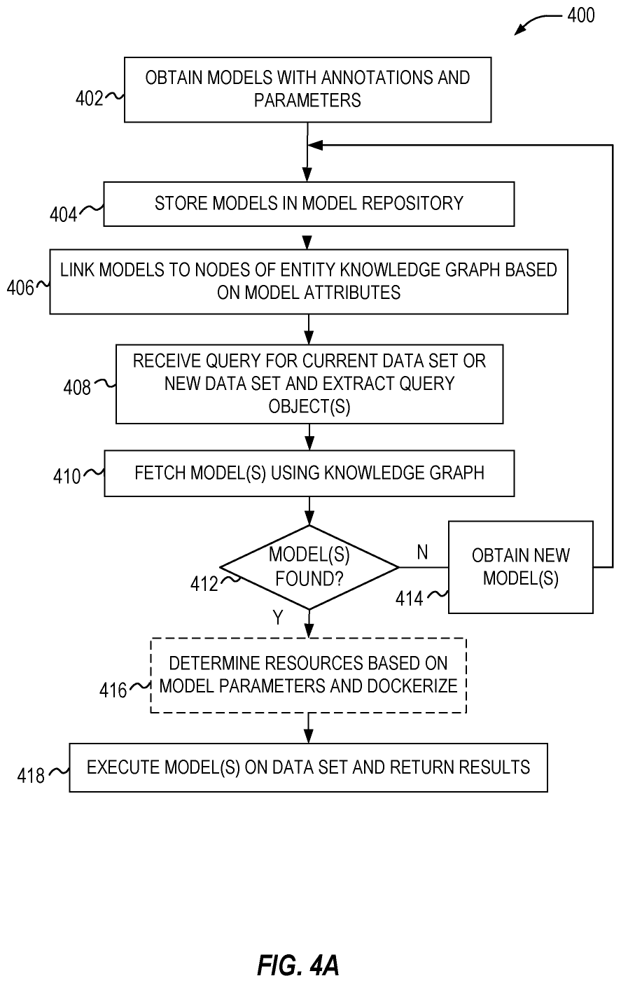

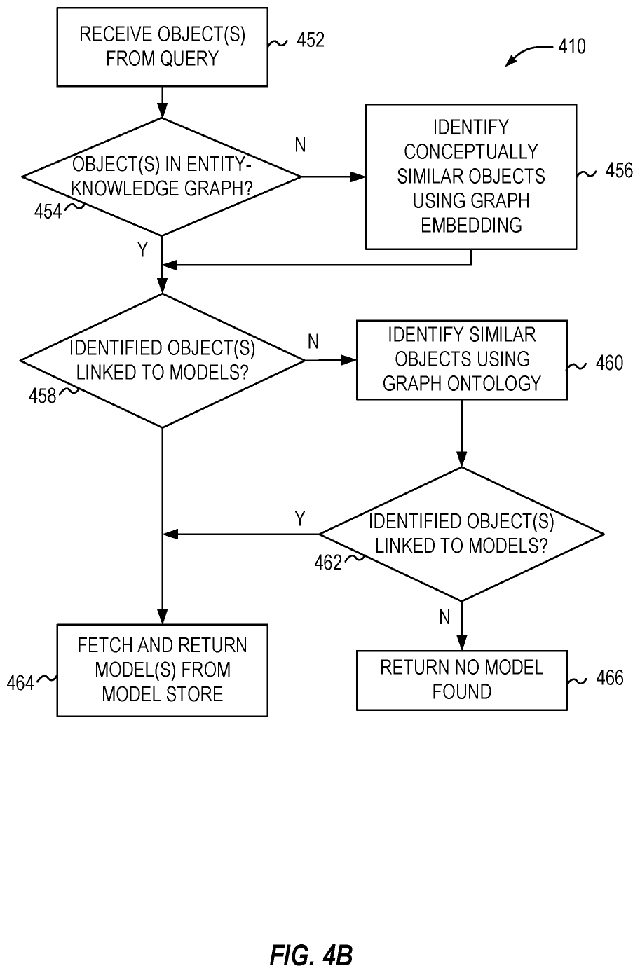

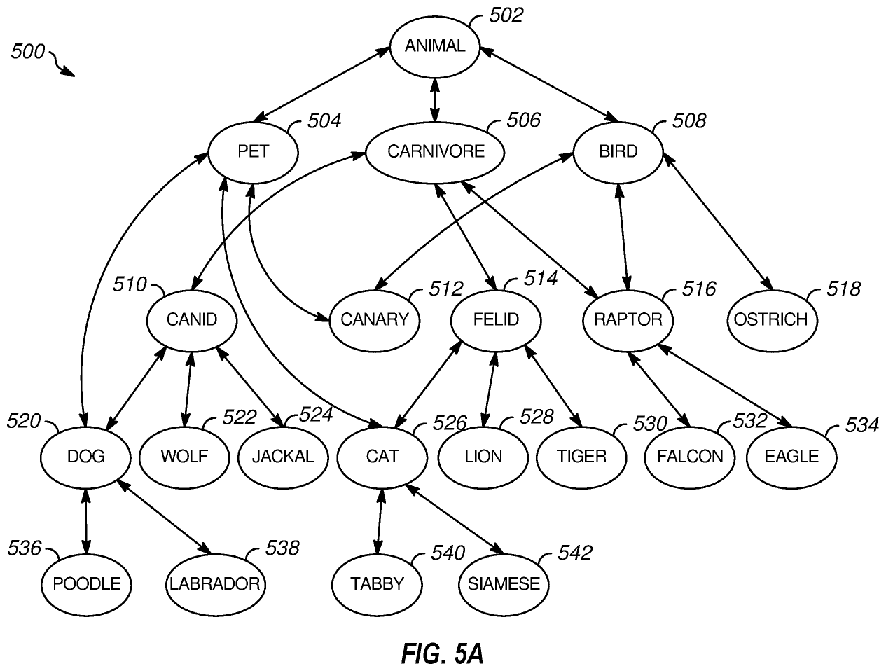

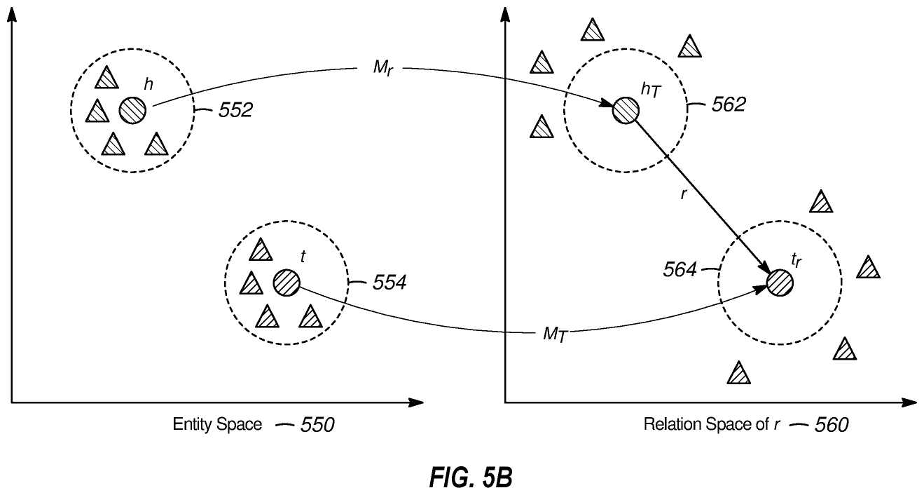

As described below with reference to FIGS. 4A-5B, the recognition models 1-5 in the model repository 112 are linked to the entity-knowledge graph database 114 so that a search for an object in the database 114 returns one or more linked models from the model repository 112. The links between the recognition models 1-5 in the model repository 112 and the entities A-G in the knowledge graph database 114 are generated using a knowledge graph update process 116. The process 116 updates the entity-knowledge graph database 114 with links to the recognition models 102 based on the model annotations 105 of the recognition models 102 as the recognition models 102 are ingested into the model repository 112 by the model ingestion process 108.

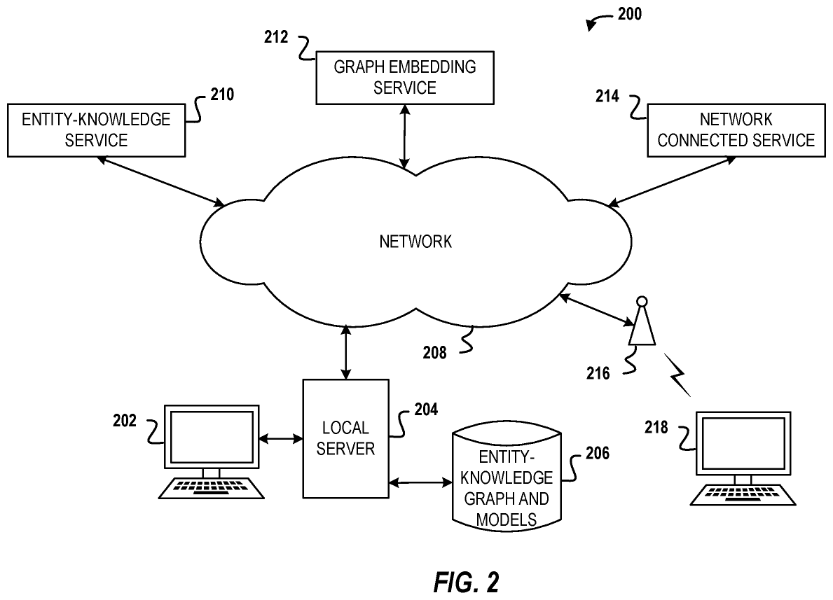

As shown in FIG. 1, some entities in the example entity-knowledge graph database 114 may be linked to multiple models 1-5, some models may be linked to multiple entities, some entities may not be linked to any model, and some models may not be linked to any entity. For example, entity D is linked to model 1 and to model 4 and entity C is linked to models 3 and 5. Model 1 is linked to entities B, D and E and model 5 is linked to entities F and C. Model 2 is not linked to any entity and entities A and G are not linked to any model. Ideally, every model in the model repository 112 is linked to at least one entity in the entity-knowledge graph database 114. During model ingestion 108, when an entity cannot be found based on the annotations 105 of a model 102, the knowledge graph update process 116 may add entity data, from example, from an entity-knowledge service, such as the service 210 shown in FIG. 2, so that each ingested model is directly linked to at least one entity in the entity-knowledge graph database 114.

The system 100 includes a block 118 that receives queries. The data sets associated with the queries may be provided to the model selection and serving process 126. As described above, in the illustrated examples, a data set may be an image file or video file and an example query may be to determine whether an object or class of objects is represented in the data set. A block 120 of the system 100 determines whether the queried object(s) exist in the entity-knowledge graph 114. If the object(s) do not exist in the knowledge graph 114, the example system 100 includes a process 122 that accesses a graph embedding process 124, as described below with reference to FIGS. 4B, 5A and 5B, to identify entities in the entity-knowledge graph that may have similar characteristics to the queried object(s). The example blocks 120, 122, and/or 124 use the entity-knowledge graph database 114 to identify one or more recognition models 1-5 in the model repository 112 that may be used to satisfy the query. These recognition models are then provided to the model selection and serving process 126 which processes the provided or indicated data set using the selected model(s) to provide prediction results 128. The operation of the system 100 is described in more detail below, with reference to FIGS. 4A through 5B.

FIG. 2 is a system diagram showing an example AI operating environment 200. The example environment 200 includes a user terminal 202 coupled to a local server 204. The example local server 204 may also be coupled to a data store 206 that may include the entity-knowledge graph database 114 and the model repository 112. The local server 204 may also be coupled to a network 208 which couples the local server 204 to an entity-knowledge service 210, a graph embedding service 212, a network connected service 214. Another user terminal 218 may also be coupled to the network 208 via an access point 216. The network 208 may be a local area network (LAN), a wide area network (WAN), or a global information network (e.g., the Internet).

FIG. 2 shows two environments in which the system 100 may be implemented. In the first environment the system 100 is primarily implemented on the local server 204. In this embodiment, the local server 204 may receive the data sets and queries, retrieve one or more of the recognition models 1-5 from the data store 206 execute the recognition models on the data set and display determined prediction results 128 via the user terminal 202. This embodiment, however, may access the graph embedding service 212 via the network 208. As described below with reference to FIGS. 4A and 4B, some recognition models 102 may need more resources than are available to the local server 204. In this instance, the system 100 implemented on the local server 204 may request additional resources from the network connected (cloud) service 214. Similarly, the graph embedding process 124 may require more resources than are available to the local server 204. In this instance, the system 100 implemented on the local server 204 may access the graph embedding service 212 via the network 208 in order to identify entities in the entity-knowledge graph database 114 that are conceptually similar to the target object(s) in the query and, thus, may be used to satisfy the query. The local server 204 may also use the entity-knowledge service 210 to obtain or build the entity-knowledge graph database 114 held in the data store 206.

In the second environment shown in FIG. 2, the system 100 is implemented primarily using resources available to the network connected service 214. In this embodiment, a user terminal 218, accessing the network 208 via the access point 216, may control allocated resources of the network connected service 214. These resources may include one or more processors, memories, and data stores (not shown) that may perform functions similar to the local server 204 and data store 206. In this instance, resources available via the network connected service 214 may obtain recognition models 102 from the user terminal 218 or from other services (not shown) coupled to the network 208 to build the model repository 112. Similarly, the network connected service 214 may build the entity-knowledge graph database 114 using the entity-knowledge service 210. Alternatively, the network connected service 214 may access the entity-knowledge service 210 as the entity-knowledge graph database 114 and may link entities in the entity-knowledge graph database 114 to a model repository service (not shown) that is either collocated with, or separate from the entity-knowledge service 210 and/or the network connected service 214. The system 100 runs, at least in part, on the allocated resources of the network-connected service 214 and may employ the graph embedding service 212 to identify conceptually similar models 102 as described below with reference to FIGS. 4B through 5B.

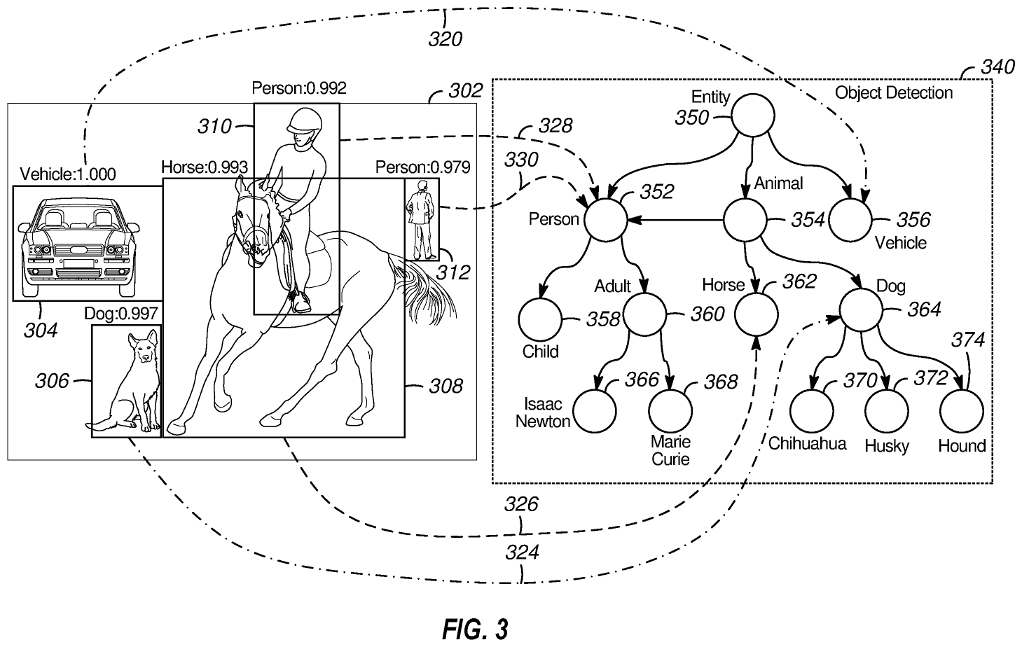

FIG. 3 is a diagram useful for describing visual entity recognition according to an example embodiment. FIG. 3 includes an image 302, and an entity-knowledge graph database 340. Although not shown, the entities in the entity-knowledge graph database 114 are linked to recognition models 102 in a model repository 112. The picture 302 includes images of a pick-up truck 304, a dog 306, a horse 308 and two people 310 and 312. The example entity graph database 114 includes nodes or vertexes connected by edges. The example database 340 is ontologically organized such that nodes corresponding to specific entities are child nodes of nodes corresponding to more general entities.

In the example shown in FIG. 3, a first level node 350 corresponds to a generalized entity category. Node 350 is coupled by respective edges to three second level nodes including a person node 352, animal node 354, and vehicle node 356. Person node 352, in turn, is coupled to third level node 358 for a child and third level node 360 for an adult. Adult node 360 is coupled to two fourth level nodes 366 and 368 corresponding to specific persons, Isaac Newton and Marie Curie. Similarly, second level animal node 354 is coupled to the person node 352, a horse node 362, and a dog node 364. Dog node 364 is coupled to three specific dog-type nodes including Chihuahua 370, husky 372, and hound 374. The database 340 is greatly simplified and is provided only as an illustration. An actual entity-knowledge graph database 114, for example, DBPEDIA, Microsoft Satori, and/or Google Graph, may include many more classes, each class including many more entities. Furthermore, the entity-knowledge database 114 may not have a tree structure, for example, the entity-knowledge graph database 114 may be an acyclic graph database. With respect to the entity-knowledge graph database 340, when traversing the nodes from bottom to top, the edges connecting to nodes conforms to the statement “is a,” for example, the statement “a Chihuahua is a dog” conforms to the edge connecting node 372 node 364.

In operation, each of the nodes shown in the entity-knowledge graph database 340 may be linked to one or more recognition models (not shown in FIG. 3), as described above. A model may be directly or indirectly linked to a node in the entity-knowledge graph database 340. For example, a recognition model for a horse may be directly linked to the horse node 362 and indirectly linked, via the ontology of the graph database 340, to the animal node 354.

Using the database 340, a query to find a dog in the image 302 may employ ontological knowledge to determine that a dog is an animal and an animal is an entity. A search of the database 344 a model corresponding to “dog” may follow the path from node 350 to node 354 to node 364. The system would then determine whether node 364 is coupled to a recognition model and, if it is, return the recognition model code 104 to the model selection and serving block 126, to be applied to determine whether the image 302 includes a dog. In this instance, processing the image 302 with the dog model 364 identifies the dog 306 with a confidence value of 0.997.

The system 100 may recognize more than one object in a data set. For example, the image 302, shown in FIG. 3, may be the result of a query to identify all entities in the image 302 using the entity-knowledge graph database 340. The response to this query may identify all entities in the image 302 using one or more recognition models 102 associated with the entity node 350. This recognition model may be a general classification/detection service that provides an entry level classification of the image 302 as a whole and blob detection to parse out objects in the image 302. This service may also provide a general characterization of the scene in the image 302 (e.g., “outdoors” and/or “stable yard”) and outline detected blobs in the image 302 with the bounding boxes 304, 306, 308, 310, and 312. One example classification/detection system may also include general models (e.g., the second level models of the database 340) that provide a broad taxonomy of many categories which includes objects that may be searched identified in an image 302. These are entry level categories, for example, animal, person, vehicle, fashion, food_and_drink, plant, sports and other broad categories. The result returned by each recognition model 102 may be accompanied by a confidence value indicating a likelihood that the image 302 belongs to the category. The models/service associated with the node 350 may return multiple categories corresponding to the nodes 352, 354 and 356, each associated with a corresponding confidence value.

Once the entities in the image 302 have been isolated and classified, the system 100 may use the broad classifications returned by the model/service to search the knowledge graph database 340 for nodes connected to the broad entity node to determine whether more specific entities may be identified. For example, if the recognition model/service associated with the node 350 only isolates the entities and generates the bounding boxes 304, 306, 308, 310, and 312, the system 100 may process each of the bounded images indicated by the bounding boxes 304, 306, 308, 310, and 312 using each of the second level recognition models associated with the nodes 352, 354, and 356. For example, each of the bounded images may be processed by the model associated with vehicle node 356 to identify the pick-up truck 304 in the image 302 with a confidence value of 1.000, as indicated by the dashed line 320. Similarly, the system 100 may process each the bounded images using the recognition model 102 associated with animal node 354 and identify the dog 306, horse 308, person 310, and person 312 as animals Tracing farther down the entity-knowledge database 340, the system 100 may process the bounded images identified as animals using the recognition models 102 associated with the person node 352, horse node 362, and dog node 364, to identify the person 310, as indicated by the dashed line 328, with a confidence value of 0.992, the person 312, as indicated by the dashed line 330, with a confidence value of 0.979, the horse 308, as indicated by the dashed line 326, with a confidence value of 0.993, and the dog 306, as indicated by the dashed line 324, with a confidence value of 0.997.

The ontological structure of the knowledge graph database 340 may increase the accuracy of the system 100. For example, applying only the bounded images 304, 306, 308, 310, and 312 to the second level recognition models corresponding to nodes 352, 354 and 356 removes extraneous elements of the image 302 from the recognition process. Similarly, the second level recognition models further filter the bounded images so that the bounded image 304 for the pick-up truck 304 is not applied to the models 364, 362 and 352 used to recognize the dog 306, horse 308, person 310, and/or person 312.

FIG. 4A is a flow-chart diagram of an example AI recognition process according to an example embodiment which is described with reference to the system 100 shown in FIGS. 1 and 3. The example system shown in FIG. 1 has access to a plurality of recognition models 102, each including model code 104, model annotations 105, and model parameters 106. In example embodiments, the model annotations 105 describe characteristics of the target objects that the model code 104 may be used to recognize and the model parameters 106 indicate resources used to run the model 102. The model annotations 105, for example, may indicate multiple names for the target objects and/or include the features of a feature vector used by the recognition model 102 to identify the target objects. The model parameters 106 may include an indication of hardware resources, including processors and memory used to run the model code 104. For example, parameters 106 for a trained neural network recognition model may indicate a number of processing elements (e.g., processors and/or processing cores) to be configured as a neural network to execute the model efficiently. The models 102 may be based on a number of different AI recognition techniques including, without limitation, support vector machines, trained neural networks, Bayesian networks, genetic networks, and/or decision trees.

The recognition models 102 may be generated in many different ways. In one method, an expert defines the attributes of the model 102, for example, the features of a feature vector used to recognize the target objects, and then trains the model 102 using labeled training data to recognize the target objects. In another method, the model 102 may be generated by applying the labeled training data to a neural network which adjusts its coefficients of the neural network nodes using back propagation to improve its ability to recognize the target objects. However the recognition models 102 are generated, the system 100 shown in FIG. 1 has access to a large number of different recognition models 102 (e.g., from hundreds to millions).

At block 402, the system 100 obtains the available recognition models 102 and, at block 404 stores the recognition models 102 in the model repository 112 using the model ingestion process 108. The process 108 stores the models 102, including the model code 104 and/or the annotations 105 and parameters 106 into the model repository 112 of the data store 110. In some embodiments, the model repository 112 may include an indexed or unindexed database configured to store multiple recognition models 102. As shown in FIG. 1, an example model repository 112 includes five models 102 numbered 1 through 5. It is contemplated that the repository 112 may include many more models 102 organized, as described below, using the entity-knowledge graph database 114.

At block 406, the example process 400 links the models 1-5 stored in the model repository 112 to nodes in the entity knowledge graph database 114. For example, as the model ingestion process 108 is storing the models 102 into the model repository 112, the knowledge graph update process 116 may search the entity-knowledge graph database 114, using the model annotations 105 for the models 102, to identify nodes that correspond to the model annotations 105. The corresponding nodes correspond to types of entities recognized by the models 102 or that have auxiliary data (e.g., feature data) that matches the model annotations 105 of the respective models 102. When the knowledge graph update process 116 identifies one or more nodes in the entity knowledge graph based on the model annotations 105 of a particular recognition model 102, it may store a link to the model 102 in the identified node(s) of the entity-knowledge graph database 114. When the annotation data is matched to the auxiliary data of the models 102, the knowledge graph update process 116 may link the recognition model 102 in the model repository 112 to a node of the entity-knowledge graph database 114 only when there are multiple matches between the model annotations 105 and the auxiliary data associated with the node of the entity-knowledge graph database 114.

Blocks 402, 404, and 406 are executed until all of the recognition models 102 available to the system 100 have been stored into the model repository 112 and linked to nodes of the entity-knowledge graph database 114. At block 408, the process 400 receives a query for a current data set or receives a new data set and a query for the new data set. Block 408 also extracts query objects using the query entities process 118 of FIG. 1 to identify the target object(s) in the query. Block 410 then uses the entity knowledge graph 114 to fetch model(s) corresponding to the target object(s) from the data store 110, as described below with reference to FIG. 4B. When, at block 412, block 410 does not find a model, the process 400 may (block 414) obtain one or more new recognition models 102 for the object(s), for example, via an Internet search, and may branch back to block 404 to ingest the new model(s). When, at block 412, the process 400 determines that block 410 has fetched the model(s) from the model repository 112, it provides the fetched model(s) to the model selection and serving process 126. The model selection and serving process 126 may, optionally as indicated by the dashed-line block 416, analyze the parameters 106 of the fetched model(s) to determine resources to be used to run the model(s) 102, acquire any such resources, and dockerize the model 102 using the acquired resources. Alternatively, when multiple models 102 are returned by block 410, block 416 may select one or more of the models 102 based on how the resources specified in the model parameters 106 compare to the resources available to the model serving and selecting process 126.

FIG. 4B is a flowchart diagram of the example AI recognition process focusing on block 410 shown in FIG. 4A which searches for and fetches the recognition models 102. At block 452, the process of block 410 receives the extracted target object(s) from the query. At block 454, the process searches the entity-knowledge graph database 114, shown in FIG. 1, for the target object(s). If any of the target object(s) is not found in block 454, the process executes block 456 to identify conceptually similar objects using graph embedding.

FIG. 5A is an example graph diagram of an entity-knowledge graph database 500, according to an example embodiment, that is useful for describing how graph embedding and the ontology of the entity-knowledge graph database 114 may be used by the example process 400. The example graph database 500 may be used to recognize different types of animals. The database 500 has an ontological arrangement including nodes at different levels.

For example, the database 500 includes a first level node 502 that may be linked to a recognition model for all animals. Second level nodes include a node for pet, 504; carnivore, 506; and bird, 508 that are ontological descendants of the animal node 502. Third level nodes ontologically coupled to the pet node 504 include dog, 520; cat, 526; and Canary, 512. Similarly, third level nodes ontologically coupled to the carnivore node 506 include canid, 510; felid, 514; and raptor 516.

The third level nodes ontologically coupled to the bird node 508 include the Canary node 512; a raptor node 516; and an ostrich node 518. The example entity-knowledge database 500 also includes fourth level nodes ontologically coupled to the third level nodes. These include a poodle node 536, and a Labrador node, 538, linked to the dog node, 520; the dog node 520, a wolf node 522, and a jackal node 524, linked to the canid node 510; a tabby node 540 and Siamese node 542, linked to the cat node 526; the cat node 526, a lion node 528, and a tiger node 530, linked to the felid node 514; and a falcon node 532 and eagle node 534 linked to the raptor node 516.

The ontology may be used to identify objects that are similar to an object that is found in the entity-knowledge graph database 114 but is not directly linked to a recognition model 102. Graph embedding may be used to identify objects that are conceptually similar to an object that is not found in the entity-knowledge graph database 114. For example, when the object extracted from the query is “Doberman Pinscher,” block 454 does not find the object in the entity-knowledge graph database 500, shown in FIG. 5A. As shown in FIG. 4B, the process of block 410 identifies similar objects using graph embedding. Graph embedding is a process by which entities in a knowledge graph are linked based on conceptual similarities among the entities that may supersede the ontology of the entity-knowledge graph. An example of graph embedding is provided in an article by S. Jameel at al. entitled “Entity Embeddings with Conceptual Subspaces as a Basis for Plausible Reasoning,” Proceedings of the 22nd European Conference on Artificial Intelligence, pp. 1353-1361 (2016). Briefly, this article describes a method which learns a high-dimensional vector-space embedding of entities from a knowledge service such as Wikipedia® and constrains this embedding such that entities of the same semantic type are located in some lower-dimensional subspace. The semantic type of each entity may be determined using features associated with the entity.

FIG. 5B is a graph diagram illustrating methods for affiliating entities in a knowledge graph using conceptual subspaces that relate objects in a high-dimensional space, according to an example embodiment. FIG. 5B shows two spaces, an entity space 550 and a relation space 560. The feature vector of an entity defines a multi-dimensional space in which each feature corresponds to a dimension. The entity h is in a cluster 552 of other entities having similar feature vectors to the entity h. Thus, these other entities are located close to entity h in the multi-dimensional space. Similarly, the entity t is in a cluster 554 of other entities having similar feature vectors to the entity t and these other entities are located close to entity tin the multi-dimensional space. These groupings are based on feature vectors in a high-dimensional space. When the entities h and t are mapped into the relation space 560, the clusters 562 and 564 are linked by the relationship r. This relationship may be, for example, a reduced set of the more important features from the feature vector and, thus, may represent a lower dimensional space than entity space 550.

For example, entity h may correspond to the Doberman Pinscher which is in the cluster 552 with other domesticated dogs. The entity t may be a wolf in the cluster 554 with other wild canids. The clusters 552 and 554 share features and also have features that separate them. The shared features may define the relationship r. Examples of such features may be “quadruped,” “carnivore,” and “social.” Using these features to relate the two clusters may allow the process 400 to identify several models 102 in the entity-knowledge database 500 that relate to the Doberman Pinscher object. These include the dog node 520 and the nodes pet 504, poodle 536, and Labrador 538 that are ontologically coupled to the dog node 520. Due to the relationship defined by the graph embedding process 124, the identified nodes may also include the canid node 510, wolf node 522, and jackal node 524. Thus, although the entity-knowledge graph database 500 does not include Doberman Pinscher as a node, the process 400 may identify six other nodes having recognition models 102 that may be used to provide an indication of whether the image data set includes an image of a Doberman Pinscher.

Returning to FIG. 4B, after processing unknown entities at block 456 through the graph embedding process 124, block 458 determines whether the identified objects in the entity-knowledge graph database 114 are linked to recognition models 102 in the model repository 112. When the entities exist in the entity-knowledge graph database 114 but the entities are not linked to one or more recognition models 102, block 460 identifies similar objects in the entity-knowledge graph database 114 based on the graph ontology. For example, if the query object were poodle and the poodle node 536 was not directly linked to a recognition model 102, block 460 may traverse the database 500 according to the ontology to identify the dog node 520 and pet node 504 as possibly being relevant to the poodle node 536. At block 462, the process 400 determines whether the objects identified in block 460 using the graph ontology of the database 114 are linked to models 102 in the model repository 112. If none of the objects is linked to a model 102, block 466 returns an indication that no recognition model 102 was found. When recognition models 102 are linked to objects identified in block 458 or in block 462, block 464 fetches the identified recognition models 102 from the model repository 112 and returns the models 102 for processing by block 412 of FIG. 4A, described above.

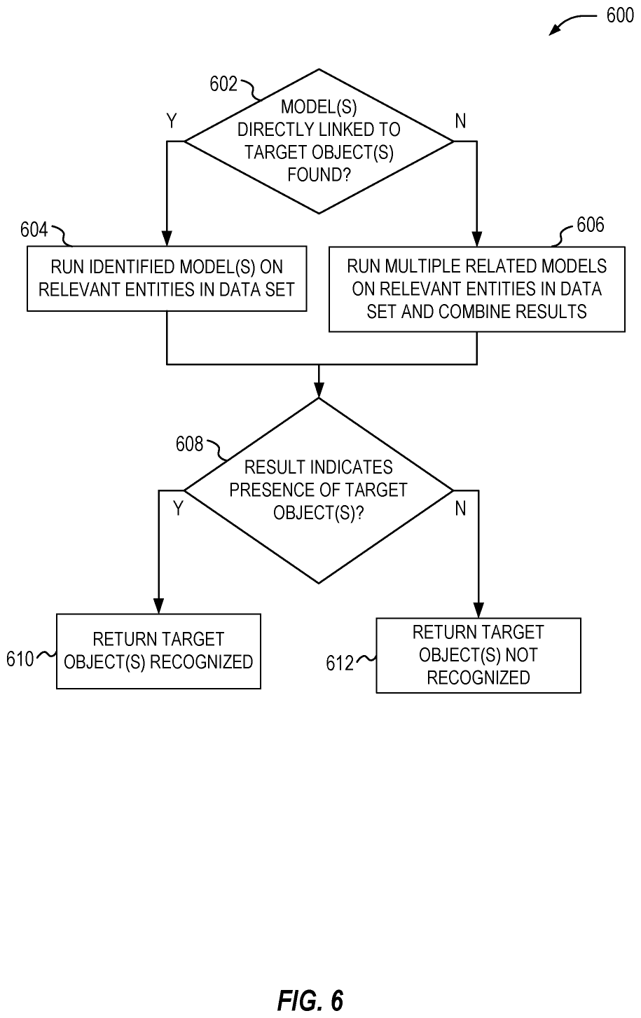

FIG. 6 is a graph diagram of a process 600 for identifying objects according to an example embodiment. The example process 600 is executed by the model selection and serving process 126, shown in FIG. 1. At block 602, the process 600 determines whether the process 400, described above, retrieved recognition models 102 that were directly linked to the target object or objects extracted from the query. If such models 102 were found, block 604 processes the data set or data sets using the directly linked models. As described above, it may be beneficial to run not only the identified recognition model 102 but all recognition models at higher levels in the ontology of the entity-knowledge graph database 114 to identify possible entities in the data set and to reduce the number of entities that may correspond to the target object(s).

If, at block 602, the process 600 determined that the retrieved recognition models are not directly linked to the target object(s) extracted from the query, the process 600 has received multiple related recognition models indirectly linked to the target object(s). In this instance, block 606 runs the multiple models 102 on the relevant entities in the data set and combines the results. Results may be combined, for example, by averaging the results or by selecting a result indicating a highest probability of detection.

The results determined by block 604 or block 606 are processed by block 608 to determine if the results indicate presence of the target object(s) in the data set. This test, for example, may compare the confidence value returned by the recognition model 102 to a threshold and indicate presence of the target object(s) when the confidence value exceeds the threshold. If the confidence value exceeds a threshold, the process 600, at step 610, returns an indication that the target object(s) has been recognized. This result may be returned with data identifying the target object(s) and the corresponding confidence values. If the confidence value is less than the threshold, block 612 returns an indication that the target object(s) has not been recognized.

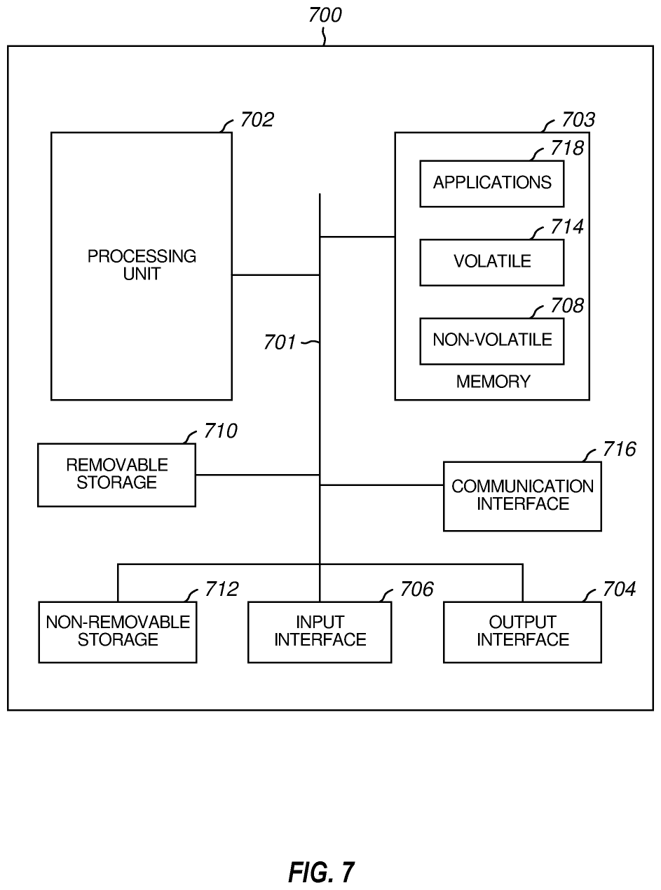

FIG. 7 is a block diagram illustrating circuitry for clients, servers, cloud-based resources for implementing algorithms and performing methods according to example embodiments. All components need not be used in various embodiments. For example, the clients, servers, and network resources may each use a different set of components, or in the case of servers, for example, larger storage devices.

One example computing device in the form of a computer 700 may include a processing unit 702, memory 703, removable storage 710, and non-removable storage 712. Although the example computing device is illustrated and described as computer 700, the computing device may be in different forms in different embodiments. For example, the computing device may instead be a smartphone, a tablet, smartwatch, or other computing device including the same or similar elements as illustrated and described with regard to FIG. 7. Devices, such as smartphones, tablets, and smartwatches, are generally collectively referred to as mobile devices or user equipment. Further, although the various data storage elements are illustrated as part of the computer 700, the storage 710 may also or alternatively include cloud-based storage accessible via a network 208, such as the Internet or server-based storage.

Memory 703 may include volatile memory 714 and non-volatile memory 708. Computer 700 may include—or have access to a computing environment that includes—a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), digital versatile disks (DVD) or other optical disk storage, magnetic cassettes, magnetic tape, magnetic disk storage or other magnetic storage devices, or any other medium capable of storing computer-readable instructions.

Computer 700 may include or have access to a computing environment that includes input interface 706, output interface 704, and a communication interface 716. Output interface 704 may provide an interface to a display device, such as a touchscreen, that also may serve as an input device. The input interface 706 may provide an interface to one or more of a touchscreen, touchpad, mouse, keyboard, camera, one or more device-specific buttons, one or more sensors integrated within or coupled via wired or wireless data connections to the computer 700, and other input devices. The computer 700 may operate in a networked environment using a communication connection to connect to one or more remote computers, such as database servers. The remote computer may include a personal computer (PC), server, router, network PC, a peer device or other common network node, or the like. The communication connection may include a local area network (LAN), a wide area network (WAN), cellular, Wi-Fi, Bluetooth, or other networks 208.

Computer-readable instructions stored on a computer-readable medium are executable by the processing unit 702 of the computer 700. A hard drive, CD-ROM, RAM, and flash memory are some examples of articles including a non-transitory computer-readable medium such as a storage device. The terms computer-readable medium and storage device do not include carrier waves to the extent carrier waves are deemed too transitory. Storage can also include networked storage such as a storage area network (SAN) indicated at 720.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. A device for identifying at least one object in a data set, the device comprising:
a memory comprising instructions; and
one or more processors in communication with the memory, wherein the one or more processors execute the instructions to:
receive a data set and a query to including the at least one object in the data set;
select at least one recognition model using an entity knowledge database including a plurality of entities corresponding to objects to be identified, wherein each recognition model of a plurality or recognition models is linked to multiple entities of the entity knowledge database; and
process the data set using the at least one selected recognition model to provide an indication of whether the data set includes the at least one object.

2. The device of claim 1, wherein the one or more processors execute further instructions to:
receive the plurality of recognition models, each recognition model including at least one annotation; and
for each recognition model:
identify at least one entity of the entity knowledge database that corresponds to the recognition model, based on the at least one annotation of the recognition model; and
link the recognition model to the at least one entity in the entity knowledge database.

3. The device of claim 1, wherein:
the at least one recognition model includes multiple recognition models and each recognition model of the multiple recognition models includes at least one parameter indicating computing resources to be used to process the data set using the recognition model; and
the one or more processors execute the instructions to process the data set by processing the data set using at least one recognition model from the multiple recognition models, the at least one recognition model having indicated computing resources that are compatible with resources available to the one or more processors.

4. The device of claim 1, wherein the one or more processors execute the instructions to obtain additional resources from a network-connected service before selecting the recognition model.

5. The device of claim 1, wherein:
the entity knowledge database is a graph database;
the entities of the entity knowledge graph database are ontologically coupled nodes of the entity knowledge graph database such that a recognition model which is directly linked to one node in the entity knowledge database is linked to all nodes in the entity knowledge database that are ontologically coupled to the one node;
the entity knowledge graph database includes a node corresponding to the at least one object and the node corresponding to the at least one object is not directly linked to a recognition model; and
the one or more processors execute the instructions to select, as the at least one recognition model, one or more recognition models directly linked to at least one node in the entity knowledge database that is ontologically coupled to the node corresponding to the at least one object.

6. The device of claim 1, wherein the one or more processors execute the instructions to:
select, as the one or more recognition models associated with the ontologically coupled nodes, a plurality of recognition models linked to a respective plurality of nodes ontologically coupled to the node corresponding to the at least one object;
process the data set using the selected plurality of recognition models; and
combine results of processing the selected plurality of recognition models to provide the indication of whether the data set includes the at least one object.

7. The device of claim 1, wherein:
the entity knowledge database is a graph database; and
the entity knowledge graph database includes a plurality of ontologically organized nodes corresponding to the at least one object at different levels of generality and the one or more processors execute the instructions to:
select, as the at least one recognition model, a plurality of recognition models associated with the plurality of nodes corresponding to the different levels of generality of the at least one object;
process the data set using the selected plurality of recognition models; and
combine results of the processing of the selected plurality of recognition models to provide the indication of whether the data set includes the at least one object.

8. A method for identifying an object in a data set, the method comprising:
searching an entity knowledge database including a plurality of nodes corresponding to objects to be identified, wherein each recognition model of a plurality of recognition models is linked to multiple nodes of the entity knowledge database;
selecting at least one recognition model of the plurality of recognition models to be used to identify the at least one object in response to the search of the entity knowledge database; and
processing the data set using the at least one selected recognition model to provide an indication of whether the data set includes the at least one object.

9. The method of claim 8, further comprising:
receiving the plurality of recognition models, each recognition model including at least one annotation; and
for each recognition model:
identifying at least one entity of the entity knowledge database that corresponds to the recognition model, based on the at least one annotation of the recognition model; and
linking the recognition model to the at least one entity in the entity knowledge database.

10. The method of claim 8, wherein:
the at least one recognition model includes multiple recognition models and each recognition model of the multiple recognition models includes at least one parameter indicating computing resources to be used to process the data set using the recognition model; and
the method further comprises processing the data set using at least one recognition model from the multiple recognition models, the at least one recognition model having indicated computing resources that are compatible with resources available to the one or more processors.

11. The method of claim 8, further comprising obtaining additional resources from a network-connected service before selecting the recognition model.

12. The method of claim 8, wherein:
the entity knowledge database is a graph database having entities that are ontologically coupled to nodes of the entity knowledge graph database such that a recognition model which is directly linked to one node in the entity knowledge database is linked to all nodes in the entity knowledge database that are ontologically coupled to the one node and the entity knowledge graph database includes a node corresponding to the at least one object and the node corresponding to the at least one object is not directly linked to a recognition model; and
the method further comprises selecting, as the at least one recognition model, one or more recognition models directly linked to at least one node in the entity knowledge database that is ontologically coupled to the node corresponding to the at least one object.

13. The method of claim 8, further comprising:
selecting, as the one or more recognition models associated with the ontologically coupled nodes, a plurality of recognition models linked to a respective plurality of nodes ontologically coupled to the node corresponding to the at least one object;
processing the data set using the selected plurality of recognition models; and
combining results of processing the selected plurality of recognition models to provide the indication of whether the data set includes the at least one object.

14. The method of claim 8, wherein:
the entity knowledge database is a graph database that includes a plurality of ontologically organized nodes corresponding to the at least one object at different levels of generality; and
the method further comprises:
selecting, as the at least one recognition model, a plurality of recognition models associated with the plurality of nodes corresponding to the different levels of generality of the at least one object;
processing the data set using the selected plurality of recognition models; and
combining results of the processing of the selected plurality of recognition models to provide the indication of whether the data set includes the at least one object.

15. A non-transitory computer-readable medium storing computer instructions for identifying an object in a data set that, when executed by one or more processors, cause the one or more processors to:
search an entity knowledge database including a plurality of nodes corresponding to objects to be identified, wherein each recognition model of a plurality of recognition models is linked to multiple nodes of the entity knowledge database;
select at least one recognition model of the plurality of recognition models to be used to identify the at least one object in response to the search of the entity knowledge database; and
process the data set using the at least one selected recognition model to provide an indication of whether the data set includes the at least one object.

16. The non-transitory computer-readable medium of claim 15, wherein the computer instructions, when executed by the one or more processors, cause the one or more processors to:
receive the plurality of recognition models, each recognition model including at least one annotation; and
for each recognition model:
identify at least one entity of the entity knowledge database that corresponds to the recognition model, based on the at least one annotation of the recognition model; and
link the recognition model to the at least one entity in the entity knowledge database.

17. The non-transitory computer-readable medium of claim 15, wherein:
the at least one recognition model includes multiple recognition models and each recognition model of the multiple recognition models includes at least one parameter indicating computing resources to be used to process the data set using the recognition model; and
the computer instructions, when executed by the one or more processors, cause the one or more processors to process the data set using at least one recognition model from the multiple recognition models, the at least one recognition model having indicated computing resources that are compatible with resources available to the one or more processors.

18. The non-transitory computer-readable medium of claim 15, further comprising computer instructions that, when executed by the one or more processors, cause the one or more processors to obtain additional resources from a network-connected service before selecting the recognition model.

19. The non-transitory computer-readable medium of claim 15, wherein:
the entity knowledge database is a graph database having entities that are ontologically coupled to nodes of the entity knowledge graph database such that a recognition model which is directly linked to one node in the entity knowledge database is linked to all nodes in the entity knowledge database that are ontologically coupled to the one node and the entity knowledge graph database includes a node corresponding to the at least one object and the node corresponding to the at least one object is not directly linked to a recognition model; and
the computer instructions, when executed by the one or more processors, cause the one or more processors to select, as the at least one recognition model, one or more recognition models directly linked to at least one node in the entity knowledge database that is ontologically coupled to the node corresponding to the at least one object.

20. The non-transitory computer-readable medium of claim 15, further comprising computer instructions that, when executed by the one or more processors, cause the one or more processors to:
select, as the one or more recognition models associated with the ontologically coupled nodes, a plurality of recognition models linked to a respective plurality of nodes ontologically coupled to the node corresponding to the at least one object;
process the data set using the selected plurality of recognition models; and
combine results of processing the selected plurality of recognition models to provide the indication of whether the data set includes the at least one object.
